(19) United States
(12) Patent Application Publication
(10) Pub. No.: US 2016/0371090 A1
(43) Pub. Date: Dec. 22, 2016

(54) TECHNIQUES FOR IMPROVING ISSUE OF INSTRUCTIONS WITH VARIABLE LATENCIES IN A MICROPROCESSOR

(71) Applicant: INTERNATIONAL BUSINESS MACHINES CORPORATION, Armonk, NY (US)

(72) Inventors: Jeffrey C. Brownscheidle, Seattle, WA (US); Sundeep Chadha, Austin, TX (US); Maureen A. Delaney, Richmond, VT (US); Dung Q. Nguyen, Austin, TX (US)

(21) Appl. No.: 15/070,672

(22) Filed: Mar. 15, 2016

Related U.S. Application Data
(63) Continuation of application No. 14/742,427, filed on Jun. 17, 2015.

(51) Int. Cl. G06F 9/38

(52) U.S. Cl. CPC G06F 9/3836

(57) ABSTRACT

Techniques are disclosed for issuing instructions in a processor. According to one embodiment of the present disclosure, an instruction tag is broadcast to wake up a plurality of instructions stored in an issue queue that are dependent on an issued instruction associated with the instruction tag. Each of the plurality of instructions has an execution latency. One or more of the instructions having an execution that will collide with an execution of one of the issued instructions if issued in a next clock cycle are identified based on the execution latencies. The identified one or more instructions are delayed from issue by at least one clock cycle after the next clock cycle.

### CROSS-REFERENCE TO RELATED APPLICATIONS

This application is a continuation of co-pending U.S. patent application Ser. No. 14/742,427, filed Jun. 17, 2015. The aforementioned related patent application is herein incorporated by reference in its entirety.

### BACKGROUND

Embodiments presented herein generally relate to issuing instructions in a processor, and more specifically, to avoiding bus collisions between issued instructions based on latency.

A conventional superscalar processor may issue instructions out-of-order with respect to a predefined program order. Because subsequent instructions are often dependent upon results of previous instructions, an issue queue in the processor may use a dependency tracking scheme to ensure that all data dependencies are followed. For instance, in one approach, the processor manages dependencies using instruction tags. At issue of an instruction in a given clock cycle to a given execution unit, the processor associates the instruction with an instruction tag that uniquely identifies the instruction within the processor. Further, during the same cycle, an execution unit may broadcast the instruction tag to the issue queue. Doing so wakes up instructions that are dependent on the associated instruction and prepares the instructions for subsequent issue.

However, instructions stored in the issue queue can have different latencies. For example, assume an instruction that is issued in a current clock cycle takes three cycles to produce resulting data. Further, assume that another instruction issued to the same execution unit in the next cycle takes two cycles to complete. Both instructions will produce respective results in the same clock cycle, resulting in a collision in a result bus of the execution unit. Typically, in the event of a result bus collision, the processor rejects the subsequently issued instruction and reissues the instruction in a later cycle. As a result, issue bandwidth and overall performance is adversely affected.

### SUMMARY

One embodiment presented herein discloses a method for issuing instructions in a processor. The method generally includes waking up a plurality of instructions stored in an issue queue that are dependent on an issued instruction of one or more issued instructions. Each of the plurality of instructions has an execution latency. The method also includes identifying, based on the execution latency of each of the plurality of instructions, one or more of the plurality of instructions having an execution that will collide with an execution of one of the issued instructions if issued in a next clock cycle. The identified one or more instructions are delayed from issue by at least one clock cycle after the next clock cycle.

### BRIEF DESCRIPTION OF THE SEVERAL VIEWS OF THE DRAWINGS

FIG. 1 illustrates an example computing system configured with a processor that issues instructions of variable latencies, according to one embodiment.

FIG. 2 further illustrates the processor described relative to FIG. 1, according to one embodiment.

FIG. 3 illustrates an example instruction selection in an issue queue storing instructions of variable latencies, according to one embodiment.

FIG. 4 illustrates a schematic diagram of an example implementation for blocking an instruction from issue selection based on latency, according to one embodiment.

FIG. 5 illustrates a method for selecting an instruction for issue based on latency, according to one embodiment.

### DETAILED DESCRIPTION

Embodiments presented herein describe techniques for issuing instructions in a processor. More specifically, embodiments provide techniques for blocking instructions in an issue queue from selection during a current clock cycle based on instruction latency.

In one embodiment, the processor provides a variable latency pipe that stores instruction tags associated with instructions issued form the issue queue. An instruction tag uniquely identifies a given instruction within the processor and also tracks dependencies of other instructions in the issue queue. The variable latency pipe is an N-entry data structure that stores each instruction tag based on latency of the associated instruction. At each clock cycle, the latency pipe releases the instruction tag stored in the tail of the pipe for broadcast to consuming facilities. The latency pipe also shifts down each of the remaining instruction tags.

Further, each position in the latency pipe represents a clock cycle latency of an underlying instruction in the execution pipeline, in descending order. For example, an instruction tag stored in the tail of the pipeline indicates that the instruction associated with the instruction tag will produce a result in one clock cycle (i.e., in the next clock cycle). As another example, an instruction tag stored one position above the tail position indicates that the associated instruction will produce a result in two clock cycles. Advantageously, the latency pipe allows consuming facilities of the processor, such as the issue queue, to track latencies of instructions issued to a given execution unit.

When an execution unit of the processor executes a given instruction, the execution unit broadcasts the instruction tag associated with a previously issued instruction to the issue queue. Doing so wakes up dependent instructions that may execute in the same execution unit. In addition, latency pipe information is broadcast to the issue queue (e.g., as a bit vector). Such information may specify positions in the latency pipe that are occupied (and unoccupied) by instruction tags. Each instruction may evaluate the latency pipe information to determine whether the instruction will collide with the executing instruction if issued in the next clock cycle. If so, the instruction blocks itself from issue (e.g., by deactivating a ready bit encoded in the instruction in the issue queue).

For example, assume that, in a given cycle, the latency pipe broadcasts an instruction tag that causes a dependent instruction to wake up. The latency of the dependent instruction is two cycles. Further, assume that, in the same cycle, the variable latency pipe stores an instruction tag in a position immediately above the tail position (i.e., the associated instruction will complete execution in two cycles). The instruction evaluates the latency pipe information that indicates position information and determines that, if issued, the dependent instruction will collide with the instruction associated with the instruction tag stored in the aforementioned position. To prevent the collision, the instruction blocks itself from issue.

In one embodiment, an instruction selection logic in the processor bypasses instructions that are blocked from issue. Typically, at a given clock cycle, the instruction selection logic selects the stored oldest instruction for issue. However, if the oldest instruction is blocked from issue, the instruction selection logic does not select that instruction for issue in the next clock cycle. Not selecting the blocked instruction prevents a bus collision with a previously issued instruction, where the previously issued instruction would produce a result during the same cycle as the blocked instruction. Instead, the instruction selection logic may select the oldest dependent instruction in the issue queue that is not blocked from issue.

However, if all dependent instructions are blocked in the current cycle, then the instruction selection logic does not select any of the dependent instructions for issue in the next cycle. Instead, the processor may clock gate the execution unit in the next cycle. That is, rather than allow a result bus collision to occur (and thus re-issue the later-issued instruction in a subsequent clock cycle), the execution unit does not execute any newly-issued instructions in the current clock cycle as a result of the clock gating. Doing so allows the processor to preserve issue bandwidth and power consumption.

Advantageously, blocking instructions from issue to an execution unit prevents collisions in the result bus of the execution unit. Further, by blocking an instruction based on latency (e.g., of the instruction and of previously issued instructions), the execution unit avoids rejecting and re-issuing the instruction that would result from a collision with a previously issued instruction. As a result, the processor does not waste extra clock cycles resulting from the reject and re-issue. Instead, the processor may select other instructions ready for issue that will not collide with previously issued instructions. Further still, as stated, the processor may clock gate the execution unit if the all issuable instructions are blocked. Doing so saves instruction issue bandwidth and power consumption.

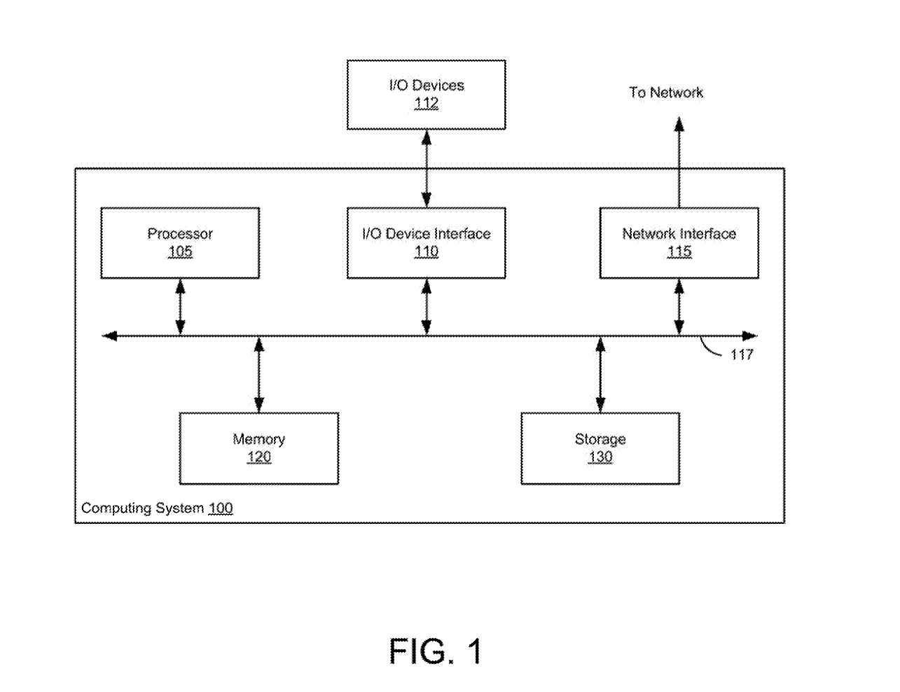

FIG. 1 illustrates an example computing system 100 that includes a processor 105 configured to prevent bus collisions between issued instructions, according to one embodiment. As shown, the computing system 100 further includes, without limitation, a network interface 115, a memory 120, and a storage 130, each connected to a bus 117. The computing system 100 may also include an I/O device interface 110 connecting I/O devices 112 (e.g., keyboard, display, and mouse devices) to the computing system 100. Further, in context of the present disclosure, the computing system 100 is representative of a physical computing system, e.g., a desktop computer, laptop computer, etc. Of course, the computing system 100 will include a variety of additional hardware components.

The processor 105 retrieves and executes programming instructions stored in the memory 120 as well as stores and retrieves application data residing in the storage 130. The bus 117 is used to transmit programming instructions and application data between the processor 105, I/O device interface 110, network interface 115, memory 120, and storage 130. The memory 120 is generally included to be representative of a random access memory. The storage 130 may be a combination of fixed and/or removable storage devices, such as fixed disc drives, removable memory cards, or optical storage, network attached storage (NAS), or a storage-area network (SAN).

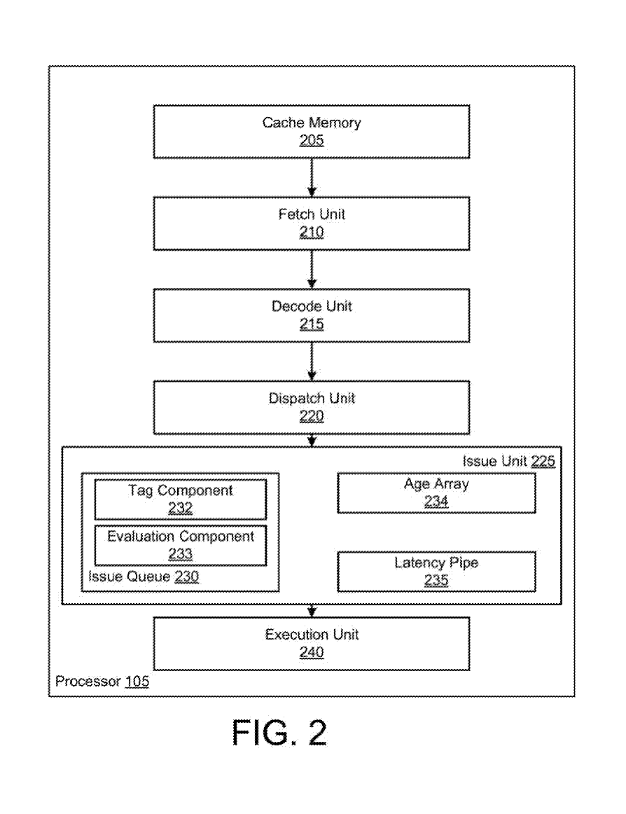

FIG. 2 further illustrates the processor 105, according to one embodiment. As shown, the processor 105 includes a cache memory 205, a fetch unit 210, a decode unit 215, a dispatch unit 220, an issue unit 225, and an execution unit 240. Of course, the processor 105 may include additional components not shown in FIG. 2. The cache memory 205 may receive processor instructions from the memory 120, storage 130, network interface 115, or other sources not shown.

The cache memory 205 connects with the fetch unit 210. The fetch unit 210 fetches multiple instructions from the cache memory 205. Instructions may be in the form of an instruction stream that includes a series or a sequence of instructions. The fetch unit 210 connects with the decode unit 215. The decode unit 215 decodes instructions as resources of the processor 105 become available. The decode unit 215 connects with a dispatch unit 220. The dispatch unit 220 connects with the issue unit 225. In one embodiment, the dispatch unit 220 dispatches one or more instructions to the issue unit 225 during a processor 105 clock cycle.

As shown, the issue unit 225 includes an issue queue 230, an age array 234, and a latency pipe 235. The issue queue 230 includes an instruction data store that stores issue queue 230 instructions as entries. For example, an issue queue that stores twenty-four instructions uses an instruction data store with twenty-four storage entries. The issue queue 230 may include an age array 234 that tracks relative age data for each instruction within the instruction data store. The issue queue 230 may also include instruction selection logic that determines which of the stored instructions to issue at a given clock cycle. For example, the instruction selection logic may prioritize older instructions that have been previously rejected (e.g., due to collisions with other issuing instructions) to issue over younger instructions in the issue queue 230. The issue unit 225 connects with an execution unit 240. The execution unit 240 may include multiple execution units that execute instructions from the issue queue 230 or other instructions.

In one embodiment, each entry in the issue queue 230 is encoded with latency bits that indicate a number of clock cycles the instruction takes to complete execution. In addition, each entry is encoded with a ready bit that, if set, indicates that the instruction is ready for issue. If cleared, the ready bit indicates that one or more conditions exist that blocks the instruction from issue in a next cycle. An example condition is if the instruction would collide with a previously issued instruction if issued in the next cycle to the same execution unit 240. In such a case, the ready bit may be deactivated. By deactivating the ready bit, the instruction selection logic bypasses the instruction when determining which instruction (if any) to issue in the next cycle.

In one embodiment, the issue queue 230 includes a tag component 232. At issue of a given instruction during a clock cycle, the tag component 232 associates an instruction tag with that instruction. The instruction tag uniquely identifies the instruction within the processor 105. The execution unit 240 may broadcast the instruction tag to other consuming facilities of the processor 105. For example, the execution unit 240 may broadcast the instruction tag to instructions stored in the issue queue 230. In turn, each instruction can evaluate the instruction tag to determine dependencies that the instruction may have to the instruction associated with the instruction tag. If a given instruction is dependent on that instruction, the instruction wakes up for potential subsequent issue. As another example, the execution unit 240 may broadcast the instruction tag to a completion logic in the processor 105 to indicate that the underlying instruction has finished execution.

The latency pipe 235 is an N-entry data structure that stores one or more instruction tags. Further, the latency pipe 235 stores each instruction tag based on a latency of the instruction associated with the instruction tag. The latency pipe 235 writes the instruction tag at an index that matches the latency of the associated instruction. Further still, at each subsequent clock cycle, the latency pipe 235 shifts each stored instruction tag down a position and releases the instruction tag at the tail of the latency pipe 235. As a result, the instruction tag is released during the clock cycle that the associated instruction completes execution. The latency pipe 235 outputs the instruction tag to a broadcast multiplexor. The broadcast multiplexor may broadcast the instruction tag to consuming facilities (e.g., the issue queue 230, completion logic, rename logic, etc.). Generally, the instruction tag is broadcast two cycles before register write-back.

As stated, an instruction stored in the issue queue 230 may block itself from issue in a next cycle if issuing the instruction would result in a bus collision with a previously issued instruction. To do so, an instruction may evaluate latencies of issued instructions via the latency pipe 235. For instance, when the latency pipe 235 releases an instruction tag for broadcast, the latency pipe 235 may also send a bit vector representing the latency pipe 235 to the issue queue 230. The bit vector indicates latency positions occupied by instruction tags. An evaluation component 233 of the instruction selection logic may compare the latency bits of a given instruction relative to the bit positions in the bit vector. The evaluation component 233 does so to determine whether a latency bit in the instruction is set in the same position as a set bit in the latency bit vector. If so, then the instruction, if issued, will collide with a corresponding issued instruction. The instruction may block itself from issue on the next cycle by deactivating the ready bit. Consequently, the instruction selection logic bypasses this instruction when determining which instruction to issue in the next cycle.

In one embodiment, the processor 105 may include a gating logic (not shown) that clock gates the execution unit 240 in the event that all dependent instructions are blocked from issue in a next cycle. That is, rather than reject a dependent instruction in the next cycle due to a collision, the gating logic instead saves power consumption by clock gating the execution unit 240.

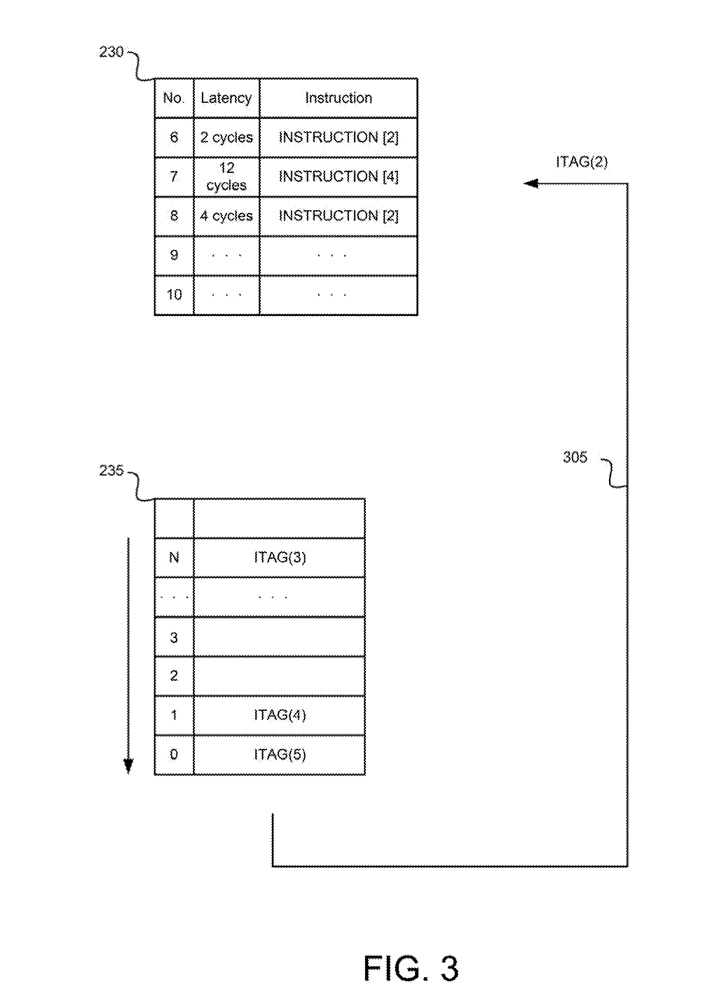

FIG. 3 illustrates an example instruction selection in the issue queue 230. Illustratively, the issue queue 230 includes a number of instruction entries, listed by program number (i.e., 6-10, and so on). Of course, in practice the instruction entries may be issued from the issue queue 230 out of order. Further, each instruction entry in the issue queue 230 specifies a latency of the instruction. For instance, instruction entry 6 specifies a latency of two cycles, instruction entry 7 specifies a latency of twelve cycles, instruction entry 8 specifies a latency of four cycles, and so on. Each instruction entry may also indicate operand dependencies, indicated by the bracketed numbers depicted in FIG. 3. For instance, instruction entries 6 and 8 are dependent on instruction 2. Instruction entry 7 is dependent on instruction 4. Of course, the issue queue 230 may include more information associated with each stored instruction entry.

Illustratively, the latency pipe 235 stores instruction tags (listed as ITAGs) associated with instructions previously issued from the issue queue 230. Each stored instruction tag may include information that uniquely identifies the associated instruction, such as type information, thread information, and instruction tag identifier. Of course, the instruction tag may include other information associated with the instruction. Illustratively, the latency pipe 235 is structured in descending order by latency, with the head of the pipe 235 being position N and the tail of the pipe 235 being position 0. In this example, FIG. 3 depicts each instruction tag by a program number of the associated instruction. For instance, ITAG(3) stored at position N is an instruction tag that is associated with instruction 3, and so on.

As stated, at each clock cycle, the latency pipe 235 releases the instruction tag stored at position 0 and shifts the other stored instruction tags down by one position. Further, the latency pipe 235 feeds the instruction tag to a broadcast multiplexor (not shown), which broadcasts the instruction tag to the issue queue 230. FIG. 3 depicts ITAG(2) being released from the latency pipe 235 and broadcasted to the issue queue 230 (at 305). The instruction tags are shifted down to the positions currently shown in FIG. 3.

As shown, some positions in the latency pipe 235 are unoccupied by instruction tags. For instance, positions 2 and 3 of the latency pipe 235 do not store an instruction tag. The evaluation component 233 may use the occupied and unoccupied positions of the latency pipe 235 to determine whether a stored instruction may collide with a previously issued instruction. As stated, the latency pipe 235 may also broadcast a bit vector indicating occupied positions in the pipe 235. The evaluation component 233 compares the latency bits of each entry with the bit vector to determine whether a set bit of a given instruction is in the same bit position as a set bit in the bit vector. If so, then the instruction will collide, in the next clock cycle, with an issued instruction corresponding to the bit position in the bit vector.

In this example, at 305, an instruction tag corresponding to instruction entry 2 is broadcast to the issue queue 230. The broadcast wakes up instructions having dependencies with instruction entry 2. In this case, instruction entries 6 and 8 wake up. Each instruction sets a respective ready bit to indicate that the instruction is ready to issue. A bit vector representing the latency pipe 235 is also broadcast to the issue queue 230. The evaluation component 233 compares the dependent instruction latencies with the issued instruction latencies indicated by the latency pipe 235. In this case, instruction entry 6, which has a latency of two clock cycles, conflicts with the instruction entry 4, which completes in two clock cycles, as indicated by the latency pipe 235. As a result, instruction entry 6 blocks itself from issue, e.g., by clearing the ready bit. By contrast, instruction entry 8, which has a latency of four clock cycles, does not appear to conflict with any of the issued instructions, based on the latency pipe 235. The instruction selection logic may select instruction entry 8 for issue.

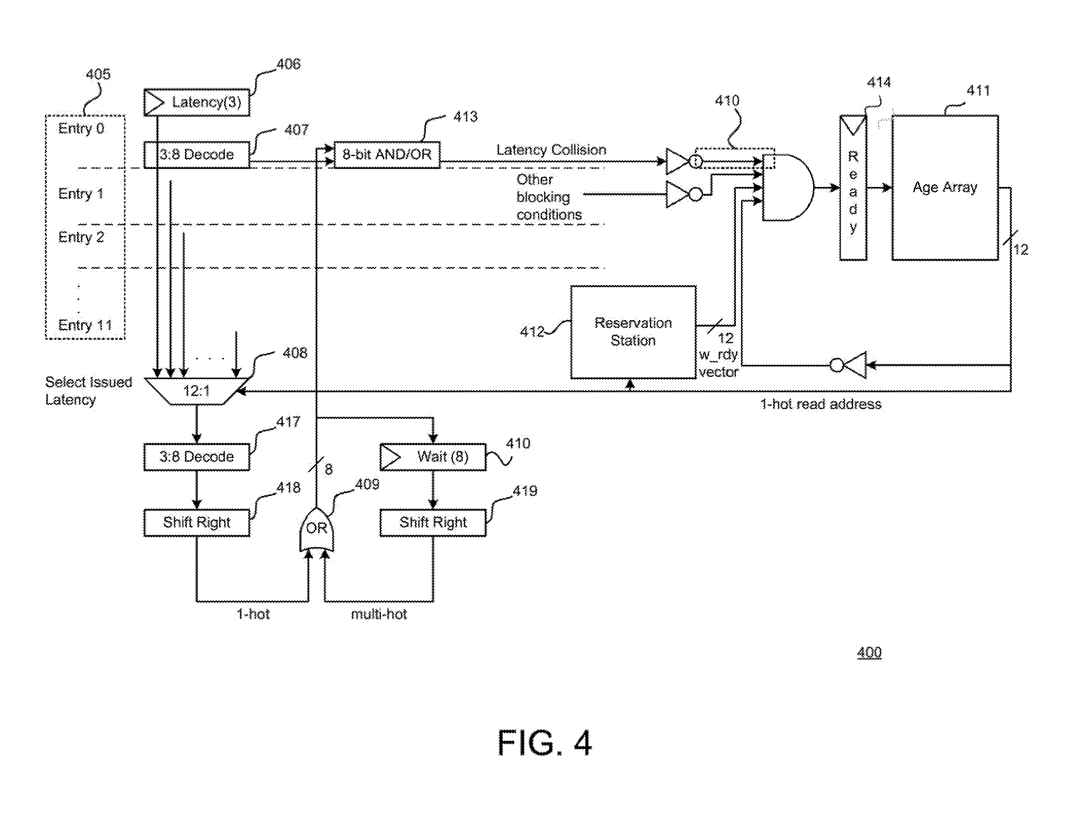

FIG. 4 illustrates a schematic diagram 400 of an example implementation for blocking an instruction from issue selection based on latency, according to one embodiment. As shown, the diagram 400 displays twelve instruction entries 405 of an issue queue (i.e., Entry 0-Entry 11). Illustratively, each of the entries 405 are encoded a 3-bit latency field. A decoding unit 407 may decode the latency bits to determine a clock cycle latency associated with each entry 405. A multiplexor 408 receives the latency bits as input.

An age array 411 tracks relative ages of each entry 405. The age array 411 may send a 12-bit vector having a 1-hot read address indicating the oldest ready entry of the entries 405 (i.e., the entry being selected for issue in the current clock cycle) to the multiplexor 408. The multiplexor 408 outputs the bits corresponding to the oldest ready entry 405 to a decoding unit 417 that decodes the bits. The decoding unit 417 sends the bits to a shift register 418. In turn, the shift register 418 that performs a shift right operation on the bits. The shift register 418 outputs the bits to an OR gate 409. The age array 411 also sends a 12-bit source operand ready vector to a reservation station 412. The reservation station 412 stores register data for operands that are not ready for execution.

A wait register 410 represents a variable latency pipe. As shown, the wait register 410 bits are input to a shift register 419. The shift register 419 performs a shift right operation on the bits and sends the bits to the OR gate 409. The OR gate sends a result of an OR operation between the latency bits of an entry 405 and the wait register 410 bits as an 8-bit vector to an 8-bit AND/OR gate 413. The output of the AND/OR gate 413 indicates whether a potential latency collision is detected. In one embodiment, a blocking condition 410 prevents the entry 405 from being selected in such an event. As shown, other blocking conditions may exist that prevent the entry 405 from being selected. If prevented, the entry deactivates its ready bit. The reservation station 412 sends a 12-bit ready vector to an AND gate. The AND gate sends the result of the AND operation to a ready register 414.

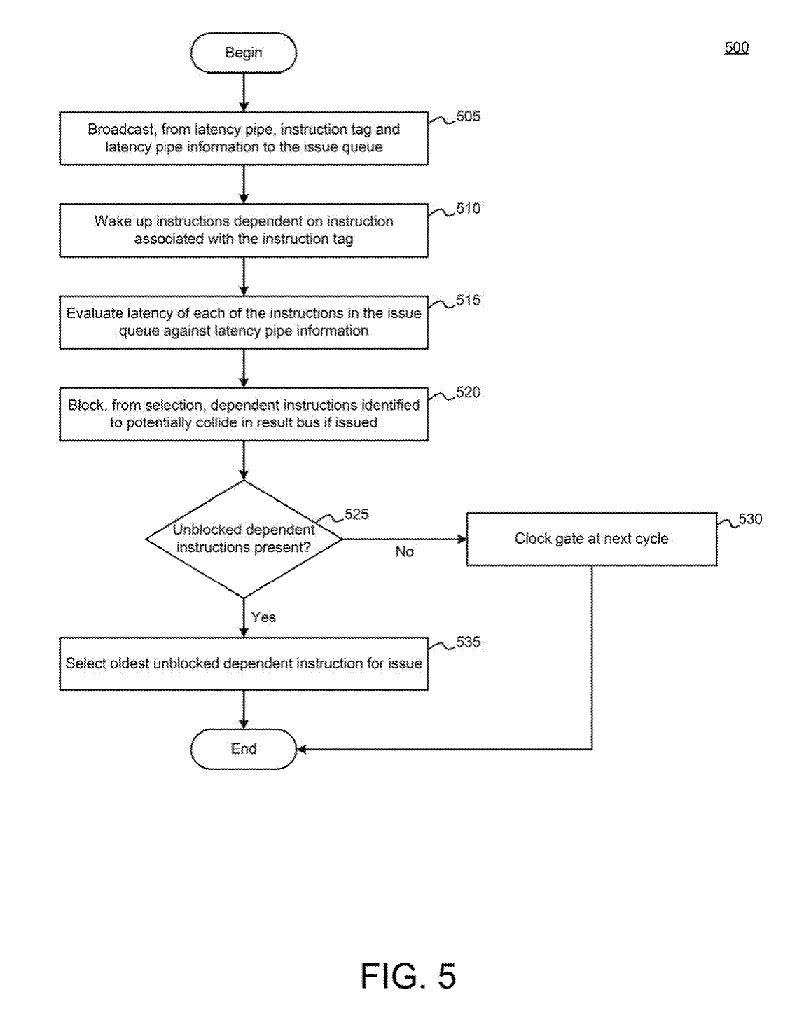

FIG. 5 illustrates a method 500 for selecting an instruction for issue based on latency, according to one embodiment. As shown, method 500 begins at step 505, where a broadcast multiplexor in the processor 105 broadcasts, from the latency pipe 235, an instruction tag and latency pipe information to the issue queue 230. The latency pipe information may be in the form of a bit vector, where each bit position in the vector represents a latency value, and a set bit indicates that an instruction tag is occupying a corresponding position in the latency pipe 235.

At step 510, the broadcast instruction tag wakes up instructions dependent on the associated instruction. Each of the dependent instructions may have varying latencies. A bit field encoded in each instruction may indicate the latency of the instruction. It is possible that issuing one of the dependent instructions at the next cycle may collide with a previously issued instruction executing in the execution unit 240.

At step 515, the evaluation component 233 compares the latency of each of the instructions in the issue queue 230 with the latency pipe information to determine whether any of the instructions may potentially collide with a previously issued instruction. To do so, the evaluation component 233 may compare the latency bits of a given dependent instruction with the bit vector representation of the latency pipe 235. If any of the set bits of the instruction are in the same position of a set bit of the latency pipe 235, then the evaluation component 233 may determine that the dependent instruction conflicts with the corresponding issued instruction.

At step 520, each dependent instruction identified to potentially collide in the result bus (if issued) blocks itself from selection. To do so, the dependent instruction may deactivate a ready bit encoded in the instruction. As stated, doing so prevents the instruction selection logic from selecting the instruction for issue in a next cycle. At step 525, the instruction selection logic determines whether any dependent instructions are ready to issue (i.e., not blocked). If so, then at step 535, the instruction selection logic selects the oldest unblocked dependent instruction for issue.

Otherwise, if all dependent instructions conflict with previously issued instructions and are blocked for issue at the next cycle, then at step 530, the gating logic clock gates the execution unit 240 for the next cycle. Doing so saves power consumption in the processor 105 by not having to reject and later re-issue a conflicting instruction.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments presented herein may be devised without departing from the basic scope thereof, and the scope thereof is determined by the claims that follow.

What is claimed is:

1. A method for issuing instructions in a processor, comprising:
waking up a plurality of instructions stored in an issue queue that are dependent on an issued instruction of one or more issued instructions, each of the plurality of instructions having an execution latency;
identifying, based on the execution latency of each of the plurality of instructions, one or more of the plurality of instructions having an execution that will collide with an execution of one of the issued instructions if issued in a next clock cycle; and
delaying the identified one or more instructions from issue by at least one clock cycle after the next clock cycle.

2. The method of claim 1, further comprising:
selecting, from the plurality of instructions not delayed from issue, one of the instructions for issue in the next clock cycle.

3. The method of claim 2, further comprising, prior to identifying the one or more of the plurality of instructions having an execution that will collide:
tracking an age of each of the plurality of the instructions stored in the instruction queue.

4. The method of claim 3, wherein the selection is an oldest of the one of the instructions not delayed from issue.

5. The method of claim 1, wherein waking up a plurality of instructions stored in the issue queue comprises:
broadcasting an instruction tag associated with the issued instruction to the issue queue, wherein instructions stored in the issue queue track instruction dependency and latency using the instruction tag; and
activating a ready bit in each of the plurality of instructions that are dependent on the issued instruction, wherein the ready bit indicates that the instruction is ready for issue in the next clock cycle.

6. The method of claim 5, wherein delaying the identified one or more instructions from issue comprises:
deactivating the ready bit of each of the identified one or more instructions.

7. The method of claim 1, further comprising:
clock gating an execution engine if all of the plurality of instructions have an execution that will collide with the execution of the issued instruction in the next clock cycle.
